(19) United States
(12) Patent Application Publication
(10) Pub. No.: US 2015/0154672 A1
(43) Pub. Date: Jun. 4, 2015

(54) DYNAMIC HIERARCHICAL FIRST RIGHT OF REFUSAL OFFER METHOD FOR ONLINE SALES TRANSACTIONS

(71) Applicant: REMARKETEERS INC., Hillsborough (CA)

(72) Inventors: Sean Peter LIPTAY, Hillsborough (CA); Stuart James LIPTAY, Lower Cape (CA); Kevin Leslie BERRY, Hillsborough (CA); Kenneth James BODNAR, Chelsea (CA)

(73) Assignee: REMARKETEERS INC., Hillsborough (CA)

(21) Appl. No.: 14/096,730

(22) Filed: Dec. 4, 2013

(51) Int. Cl. G06Q 30/06

(52) U.S. Cl. CPC G06Q 30/0605

(57) ABSTRACT

A method comprising providing an indication that a purchasable is for sale by a seller to an online sales platform connected to a communication network. Buyer data is provided for a plurality of buyers and is indicative of online shopping behavior of each of the buyers. A first group and second group of buyers is selected from the plurality of buyers in dependence on the buyer data. A first offer of sale of the purchasable is provided to each buyer of the first group of buyers and not to any other buyers. If a request to purchase the purchasable is received from one of the buyers of the first group of buyers the purchasable is sold to the one of the buyers of the first group. If a request to purchase the purchasable is not received from one of the buyers of the first group of buyers a second offer of sale of the purchasable is automatically provided to each buyer of the second group.

### FIELD OF INVENTION

The present invention relates to online sales transactions, particularly to dynamically identifying a hierarchy of groups of buyers for participating in remote sales transactions.

### BACKGROUND

Online e-commerce platforms have facilitated vendor accessibility to markets traditionally unobtainable. Sellers were once limited to cold calls, TV and print advertisements, word of mouth, brick and mortar stores, and signage to make contact with and influence decision making of customers. The nature of manual advertising and finite marketing budgets limited the portion of the general public with access to a vendor's product information, and hence limited profitability of the vendor. In particular, this was true for individuals or small businesses with modest marketing resources; consequently they were often limited to a local client base.

Today, any person with Internet access is a potential client. With the emergence of retailers' virtual storefronts and online selling and auction services, a customer simply searches for an item or service of interest, and once found, makes a purchase or offer. The relative geographic locations of the seller and buyer are of little consequence and the entire transaction is conducted over the Internet. Utilizing online services, such as Shopify®, ETSY®, Kijiji° and ebay®, global customers access millions of products and services for sale. Large corporations to mom-and pop shops now promote their purchasables to the general public—any and every user browsing online marketplaces.

Along with expanding a seller's client base, Internet shopping goes hand-in-hand with both seller and buyer anonymity. As such, selling and purchasing online increases the amount of risk that is associated with a transaction. Building trust between vendors and customers online is challenging, as one party is frequently unknown to the other. Many online marketplaces attempt to mitigate fears of unknown product quality and questionable vendor dependability by giving purchasers an opportunity to post feedback on their experience dealing with an online seller. Unfortunately, the feedback is posted by anonymous persons and so a vendor could arrange for false feedback to be posted, thereby misleading potential customers into having a false sense of security.

Another disadvantage that is associated with online selling platforms is the inability for the vendor to customize sales offers for specific clientele. An online selling platform enforces customer “equality,” as all potential purchasers are offered the same purchasing terms and conditions. Good or unique customers cannot be offered special deals as a reward for their loyalty, nor can a vendor implement selling strategies targeting potentially lucrative customers. Thus, it is challenging for a vendor to reap the benefits from relationship based selling strategies, benefits such as, reducing a customer's sense of risk, gaining a customer's trust in, and building a customer's sense of commitment to, the vendor's products. Building such relationships are mutually beneficial to both the vendor and the customer.

It would be advantageous to overcome at least some of the above mentioned disadvantages.

### SUMMARY OF THE EMBODIMENTS OF THE INVENTION

In accordance with an aspect of at least one embodiment of the invention there is provided a method comprising: providing an indication that a purchasable is for sale by a seller to an online sales platform connected to a communication network; coupling a plurality of communication devices to the communication network for communication to the online sales platform; providing buyer data for a plurality of buyers, the buyer data indicative of online shopping behavior of each buyer of the plurality of buyers, wherein each buyer of the plurality of buyers is associated with a communication device of the plurality of communication devices; selecting a first group and a second group of buyers from the plurality of buyers in dependence on the buyer data, the first group of buyers comprising at least a first buyer, the second group comprising at least a second buyer, the first buyer other than the second buyer; providing a first offer of sale of the purchasable to each buyer of the first group of buyers and other than providing the first offer of sale of the purchasable to other than each buyer of the first group of buyers, wherein the first offer of sale is accessible to each of the buyers of the first group of buyers via one of the associated plurality of communication devices; and when a request to purchase the purchasable is other than received from one of the buyers of the first group via one of the plurality of associated communication devices, automatically providing a second offer of sale of the purchasable to each buyer of the second group, wherein the second offer of sale is accessible to each of the buyers of the second group of buyers via one of the associated plurality of communication devices.

In accordance with an aspect of at least one embodiment of the invention there is provided a method comprising: providing an indication that a purchasable is for sale by a seller to an online sales platform connected to a communication network; coupling a plurality of communication devices to the communication network for communication to the online sales platform, each buyer of the plurality of buyers is associated with a communication device of the plurality of communication devices; providing buyer data for each buyer of the plurality of buyers, the buyer data indicative of online shopping behavior of each buyer of the plurality of buyers; selecting a first group and a second group of buyers from the plurality of buyers in dependence on the buyer data and data provided by the seller, the first group of buyers comprising at least a first buyer, the second group comprising at least a second buyer, the first buyer other than the second buyer, wherein the data provided by the seller is indicative of the seller's preference to select at least the first buyer from the plurality of buyers to be selected in the first group; automatically determining a first offer of sale and a second offer of sale by the online sales platform wherein the first offer of sale and the second offer of sale are dependent on the data provided by the seller, the first offer of sale expiring at a time t1 and the second offer of sale expiring at a time t2, t1 other than t2; providing the first offer of sale of the purchasable to each buyer of the first group of buyers and other than providing the first offer of sale of the purchasable to other than each buyer of the first group of buyers, wherein the first offer of sale is accessible to each of the buyers of the first group of buyers via one of the associated plurality of communication devices; and when a request to purchase the purchasable is other than received from one of the buyers of the first group via one of the plurality of associated communication devices and the first offer of sale is expired, automatically providing the second offer of sale of the purchasable to each buyer of the second group, wherein the second offer of sale is accessible to each of the buyers of the second group of buyers via one of the associated plurality of communication devices.

In accordance with an aspect of at least one embodiment of the invention there is provided a system comprising: a communication network; a plurality of communication devices coupled to the communication network, each of the plurality of communication devices associated with each buyer of a plurality of buyers; and an online server coupled to the communication network for communicating with the plurality of communication devices comprising: a memory store for storing buyer data indicative of online shopping behavior of each buyer of the plurality of buyers; and a processor for processing the buyer data for automatically selecting a first group and second group of buyers from the plurality of buyers in dependence on the buyer data and for providing a first offer of sale to each communication device associated with each buyer of the first group of buyers via the communication network and other than providing the first offer of sale of the purchasable to each communication device associated with other than each buyer of the first group of buyers and when a request to purchase the purchasable is other than received from each communication device associated with each buyer of the first group of buyers and the first offer of sale is expired, automatically providing a second offer of sale of the purchasable to each communication device associated with each buyer of the of the second group of buyers.

### BRIEF DESCRIPTION OF THE DRAWINGS

Exemplary embodiments will now be described in conjunction with the following drawings, wherein like numerals refer to elements having similar function, in which:

FIG. 1 is a simplified block diagram of companies implementing differing business strategies according to the prior art.

FIG. 2 is a simplified block diagram of an online marketplace according to the prior art.

FIG. 3 is a simplified block diagram of a system according to an embodiment of the invention.

FIG. 4 is a simplified flow diagram of a process for selling a purchasable on an online sales platform according to an embodiment of the invention.

FIG. 5 is another simplified flow diagram of a process for selling a purchasable on an online sales platform according to an embodiment of the invention.

FIG. 6 is a simplified block diagram of a system according to an embodiment of the invention.

### DETAILED DESCRIPTION OF THE EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Definitions:

a purchasable is a good or service available for purchase.

a seller is an entity/entities or individual(s) that posts to the online selling service an indication of a purchasable.

a buyer is an entity/entities or individual(s) that are known to the online selling service as a potential purchaser of the purchasable.

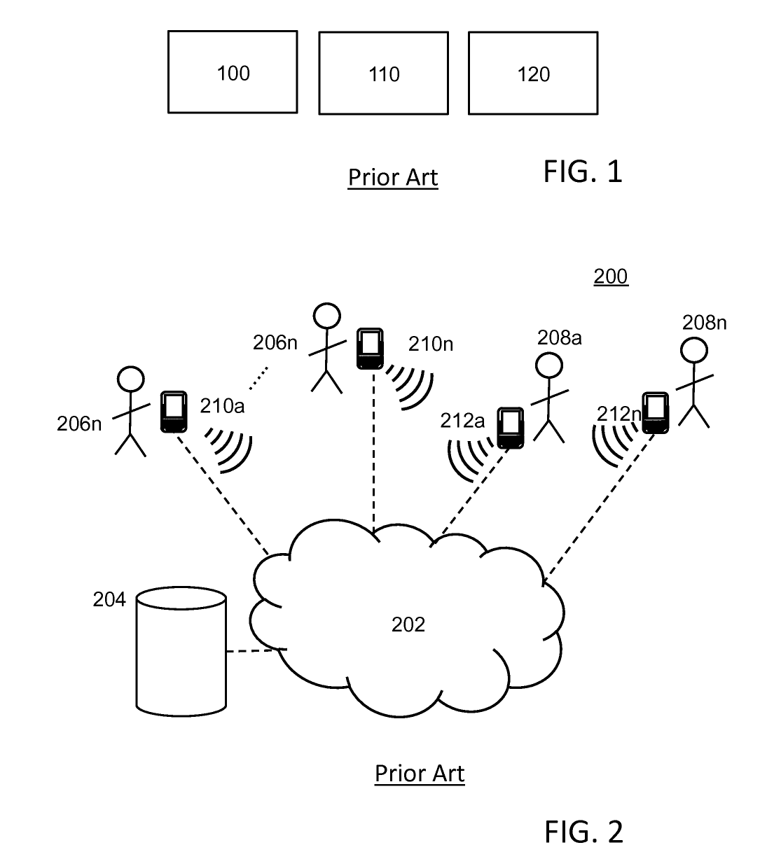

Businesses implement unique sales strategies depending on several factors such as their philosophy for maximizing profits, target customers, and the product or service they offer. Shown in FIG. 1 is a simplified block diagram of Company 100, Company 110, and Company 120, each implementing differing business strategies according to the prior art. Company 100 sells readily available consumer goods and implements a low cost, high volume marketing strategy. Moving inventory as quickly as possible is considered a priority to maximize sales. Company 110 sells luxury items and implements a sales policy of offering a low volume of products, selling to high net worth customers willing to pay for product exclusivity. Selling their products for the highest price is believed to be the key to success. Finally, company 120 enforces a sales strategy of providing quality goods at a fair price and making business deals to foster trusting relationships with clients. Gambling that these loyal, long term customers will make the business a success, businesses invest significant financial resources and man-hours speculating on the best sales strategies to maximize profitability. New product offerings, the state of the economy, and societal needs continuously change, and thus, so also do customer spending behaviors change. As a result, businesses constantly evaluate and evolve their product offerings and sales strategies in an effort to maintain profitability.

Shown in FIG. 2 is a simplified block diagram of a system according to the prior art. System 200 comprises online sales platform 204, for example ebay®, comprising a plurality of buyers 206a-206n and sellers 208a-208n with associated communication devices 210a-210n and 212a-212n, respectively, in communication with online sales platform 204 via communication network 202, such as the Internet. Alternatively, the communication network is a mobile network. When a seller posts an item for sale on online sales platform 204 the seller typically provides a text description and picture of the item, the immediate purchase price, terms of sale, and optionally offers buyers the ability to place an auction bid. The post is viewable by all of the buyers 206a-206n in communication with online sales platform 204. A buyer purchases the item, the electronic financial transaction is executed and the item is shipped to the buyer.

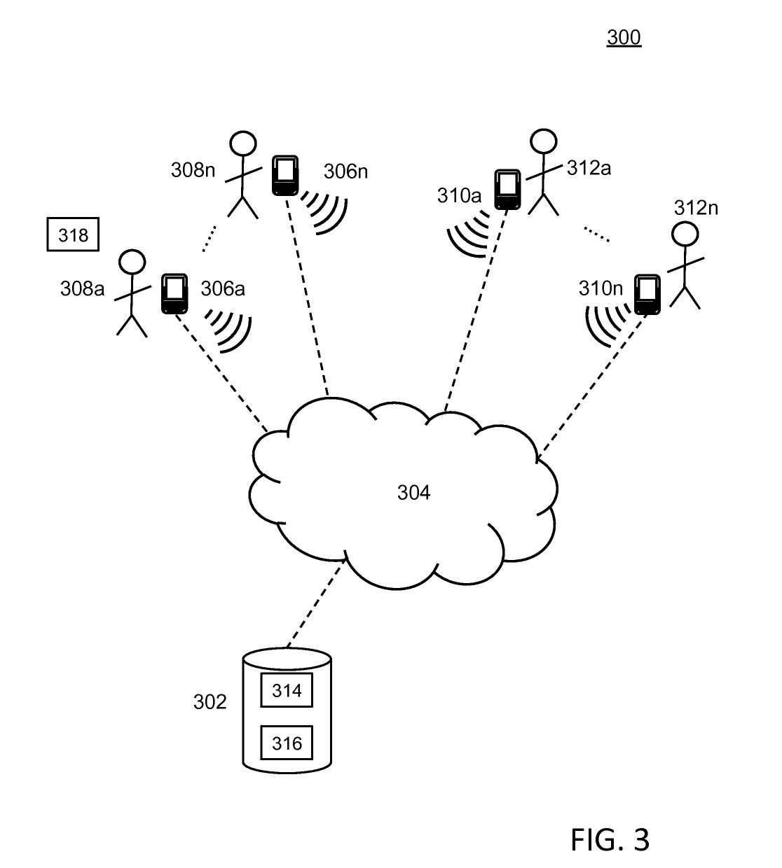

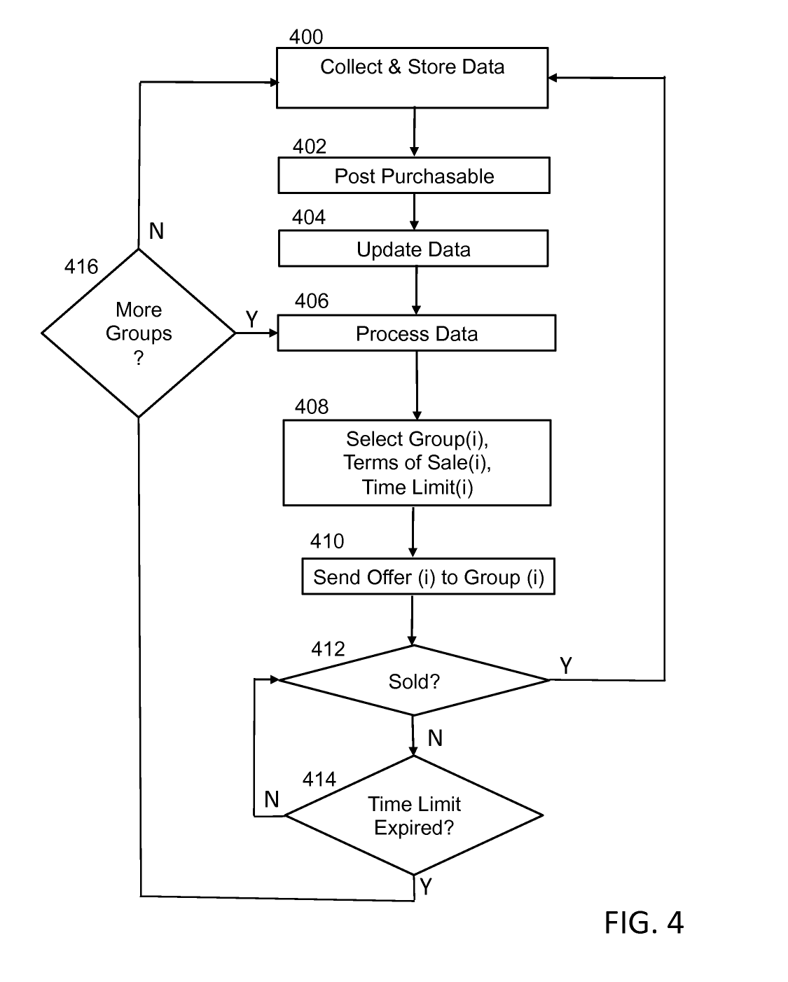

Shown in FIG. 3 is a simplified block diagram of a system according to an embodiment of the invention. System 300 comprises an online sales platform 302 in the form of a server, coupled to a network 304, for example, the Internet, and communication devices 306a-306n and 310a-310n, also coupled to network 304. Alternatively, the online platform 302 is in the form of a distributed network. Specific and non-limiting examples of communication devices 306a-306n and 310a-310n include computers, smartphones and tablets. Online sales platform 302 provides an electronic service for the online sale and purchase of purchasables to users—sellers and buyers. In this example, sellers 308a-308n and buyers 312a-312n use their associated communication devices, 306a-306n and 310a-310n, respectively, to receive messages from, and to access, online service platform 302 via network 304. In use, both sellers and buyers register with online sales platform 302 by providing contact information thereto. A specific and non-limiting example of contact information is an email address. At the time of registration, users are associated with a secret password for user verification purposes when logging into the online sales platform 302. Alternatively, security processes using other security information are implemented for user verification during login. User contact and associated security information are stored in a data store. In this example, user information is stored in the same server as online sales platform 302. Optionally, the user is associated with a username for use during user verification at login, the username is also stored in a data store and associated with the user contact and associated security information.

For each purchasable posted on online sales platform 302, the seller provides a description of the purchasable. For example, seller 308a provides a text description of a pickup that seller 308a posts for sale, such as, “2004 Red Dodge Ram pickup—115,000 miles”. Optionally, the seller 308a selects from predefined categories characteristics that describe the purchasable. Non-limiting and specific examples include seller 308a selecting “automobile,” “truck,” “Dodge,” “2004,” “Ram,” “Red,” and “less than 120,000” from categories “purchasable category,” “type,” “make,” “year,” “model,” “color” and “mileage” respectively. Alternatively, seller 308a other than provides a text description and selects from predefined categories characteristics that describe the purchasable. Optionally, seller 308a provides a photo of the purchasable.

In this example, seller 308a specifies the terms of sale for each purchasable posted on online sales platform 302. Specific and non-limiting examples include purchase price and forms of payment, such as online payment systems, i.e. PayPal®, credit card, debit, and refund policy. Optionally, the seller allows pre-approved buyers to be invoiced. Optionally, the seller indicates that the purchasable is available for auction—allowing the buyers to make competing offers as opposed to instantaneously buying the purchasable at the specified purchase price. Furthermore, the seller indicates the type of auction—for example an English, Dutch, first price or Vickery auction. Optionally, the seller indicates to the online sales platform 302 auction details, specific and non-limiting examples include the reserve price, minimum acceptable bid, the run time of the auction, etc. Another example of a term of sale is a time limit the purchasable will be available for sale.

Seller 308a provides goal data for indicating the goals of a sale of a purchasable to the online sales platform 302. For example, seller 308a indicates that the primary goal for the sale of the 2004 Red Dodge Ram pickup, as described above, is to maximize profit. Optionally, seller 308a indicates that the secondary goal of the sale, for example, is to sell the 2004 Red Dodge Ram pickup as quickly as possible. Alternatively, seller 308a indicates that the primary goal of the sale is to sell the purchasable as quickly as possible. Alternatively, the seller indicates other short term goals as goals of the sale. Optionally, the seller indicates long term business goals to the online sales platform 302. A specific and non-limiting example is to maximize current and future sales from buyers located within a specific geographic region. Optionally, the user provides other goal data for indicating other goals of the sale. The purpose for the seller to provide goal information is described in detail further below.

Still referring to FIG. 3, seller 308 information is provided on the post and available to buyers. Specific and non-limiting examples include seller name, address, contact information, and buyer feedback. Alternatively, a seller restricts the seller information that is provided to buyers.

For each of the buyers 312a-312n, shopping behaviors are tracked by online sales platform 302, and data 314 indicative thereof is stored in a data store, for example, in the same server as online sales platform 302. Data 314 also comprises data associated with purchasables bought by a buyer, for example, data extracted from the online description of a purchasable, seller goals, seller information, and terms of sale. Data 314 is processed to interpret buyers' 312a-312n shopping behaviors in a meaningful way. Such as identifying patterns in buyer shopping behavior, personal preferences, and habits. For example, identifying behavior such as a buyer usually makes purchases on the weekend, mainly purchases electronics that need repair, or only purchases used foreign cars. Other examples include the frequency of purchases made by a buyer, the average purchase price paid for a purchasable and identifying that the buyer only buys purchasables with a refund policy. Optionally, data 314 also comprises data indicative of personal information provided by the buyer to the online sales platform 302. Specific and non-limiting examples include occupation, location, age and gender.

Data 314 is also processed to identify a plurality of associated shopping behaviors of the buyer. For example, buyer 312f purchases used cars on a weekly basis from the following preferred sellers: 308a, 308g and 308h, wherein all of the preferred sellers are located in Detroit, the preferred used cars are American and are less than 2 years old. Optionally, data 314 is processed to identify other characteristics of buyers 312a-312n shopping behaviors. Furthermore, data 314 is processed to anticipate future purchases of buyers 312a-312n. A specific and non-limiting example includes applying a mathematical/statistical model to data 314 to anticipate the likelihood of future purchases by a buyer. Alternatively, other techniques are used to process data 314 to anticipate future purchases by a buyer.

For a given purchasable, data 314 is also processed to identify a hierarchy of groups of buyers from buyers 312a-312n wherein each identified group receives a limited time sales offer unique to that group. The limited time sales offers are provided sequentially to each group according to the position of the group's hierarchical rank. Optionally, a plurality of groups occupy the same rank in the hierarchy of groups. Furthermore, the offers are non-contemporaneous, in other words, the windows of time each sales offer provided to a group is valid do not overlap. Alternatively, limited time sales offers are contemporaneous. Data 314 is processed to select the members of each group and a sequence of offers to be provided to the groups that would maximize the probability of achieving the short term and long term business goals indicated by a seller. Optionally, the terms of sale are customized for each group. Furthermore, methods used to process data 314 are dependent on the seller's goals. A specific and non-limiting example includes applying a first mathematical/statistical model to data 314 when the seller has a short term goal of selling a purchasable as quickly as possible. However, a second other mathematical/statistical model is applied to data 314 when the seller has a long term goal of building a customer base in a specific geographical region. Finally, data 316 resulting from the processing of data 314 is stored in a data store, for example, in the same server as online sales platform 302. For each new purchasable posted for sale and subsequently sold on the online sales platform 302, data 314 is automatically updated and processed resulting in new data 316. Changes in buyer behavior and seller goals are automatically reflected in updated data 314 and 316.

In this embodiment of the invention, seller 308a using communication device 306a logs into online platform 302 and posts an ad of a purchasable thereon. In this example, the purchasable is motorcycle 318. Alternatively, the purchasable is not a motorcycle. Optionally, the purchasable is a service. Seller 308a provides a description for the purchasable, motorcycle 318, to online platform 302. A specific and non-limiting example of the description includes the year, make, model, and condition of motorcycle 318. Optionally, other detailed information about the purchasable is provided by seller 308a. Seller 308a indicates to online sales platform 302, for example by selecting from a menu of predefined choices, that a quick sale of motorcycle 318 is the highest priority of the sale, even more important than selling motorcycle 318 for full market value. For example, seller 308a commits to first terms of sale wherein motorcycle 318 is available for purchase at a discounted rate of 10% from the asking price of $3000 provided motorcycle 314 is sold within the first 24 hours. Otherwise, should it take longer than 24 hours to sell, seller 308a commits to second terms of sale wherein motorcycle 318 is to be sold for the full asking price of $3000. Data 314 is updated to indicate the first and second terms of sale and is then processed to result in new data 316. Based on data 314 and 316, reflecting the first and second terms of sale, the online sales platform 302 automatically selects a first group of buyers from buyers 312a-312n, to receive a first exclusive offer for the opportunity to purchase motorcycle 318 at the discounted rate. Each member of the first group is selected to maximize the probability of achieving the primary goal of the sale—to sell motorcycle 318 within 24 hours at a purchase price of $2700. Specific and non-limiting examples include identifying shopping behaviors of members of the first group such as: identifying a history of the buyer purchasing a high volume of motorcycles, the buyer has a preference for the make and model of motorcycle 318 and a quick response time to offers. Furthermore, members of the first group are also selected due to their anticipated future shopping behavior as determined by data 316. Each member of the first group of buyers is automatically contacted and provided with purchasable details. For example, buyers 312a-312e are selected as the first group of buyers. An email is sent to each of buyers 312a-312e including a description of the motorcycle 318, terms of sale, and seller 308a information. Buyers 312a-312e access the email via associated communication devices 310a-310e. Furthermore, an indication is provided in the email that only a select group of buyers has received the first offer and if motorcycle 318 is not purchased within 24 hours from the time the emails are sent another group of buyers will receive an offer to purchase motorcycle 318 and the asking price will increase to $3000. Optionally, the number of members in the first select group is provided in the email. The limited time offer sale price of $2700, the knowledge that in 24 hours the price will increase and there will be more competition is motivation for members of the first group of buyers to quickly purchase motorcycle 318.

Provided motorcycle 318 is not sold to any member of the first group within 24 hours, a second group of buyers from buyers 312f -312h is selected. Members of the second group are selected to maximize the probability of selling motorcycle 318 at a purchase price of $3000 as quickly as possible. Specific and non-limiting examples include identifying a shopping behavior of a member of the second group such as: the buyer has a preference for any 2-wheeled mode of transportation, such as scooters, dirt bikes, motorcycles and bicycles and the buyer has also bought purchasables from seller 308a in the past—an established relationship between the seller and buyer is identified. Furthermore, members of the second group are also selected due to their anticipated future shopping behavior as indicated by data 316. Each member of the second group of buyers is automatically contacted and provided with purchasable details. For example, buyers 312f -312h are selected as the second group of buyers. In this example, based on data 314 and 316, online sales platform 302 approximates an optimal time limit of 12 hours for the second offer to motivate the second group of buyers to purchase the motorcycle 318. An email is sent to each of buyers 312f -312h including a description of the motorcycle 318, terms of sale, and seller 308a information. Buyers 312f -312h access the email via associated communication devices 310f-310h. An indication is provided in the email that only a select group of buyers has received the second offer and if not purchased within 12 hours from time the email was sent another group of buyers will receive an offer to purchase motorcycle 318. Optionally, the number of members in the second select group is provided in the email. The knowledge that in 12 hours there will be more competition is motivation for members of the second group of buyers to quickly purchase motorcycle 318. Optionally, the members of the first group also receive the second email offer, however, should any buyer in the first group wish to purchase motorcycle 318 they must now pay full asking price of $3000.

Provided motorcycle 318 is not sold to any member of the first or second groups within 36 hours, a third group of buyers from buyers 312a-312n is automatically selected by online sales platform 302. Once again, the third group is selected to maximize the probability of selling motorcycle 318 at a purchase price of $3000 as quickly as possible. However, the third group of buyers comprises all of the remaining buyers 312i-312n in system 300. An email is sent to each of buyers 312i-312n including a description of the motorcycle 318, terms of sale, and seller 308a information. Buyers 312i-312n access the email via associated communication devices 310i-310n. In this example, an offer time limit is not automatically applied by the online sales platform 302 as there is no data in data 314 and data 316 to support that a time limited offer would increase the probability of selling motorcycle 318 more quickly. Optionally, the members of the first groups and second groups also receive the second email offer, however, should any buyer in the first group wish to purchase motorcycle 318 they must now pay full asking price of $3000. Alternatively, seller 308a commits to first terms of sale wherein motorcycle 318 is available for purchase at a full market value of $3000 for the first 24 hours. If it takes longer than 24 hours to sell, seller 308a commits to second terms of sale wherein motorcycle 318 is to be sold for a discounted price of $2700. Buyers provided the first sales offer will be notified that the asking price of motorcycle 318 will increase after 24 hours and they will have to decide whether they are willing to pay the full asking price to snap up the motorcycle 318 quickly, or they are willing to risk losing motorcycle 318 by delaying the purchase until the asking price has decreased to $2700.

Optionally, seller 308a indicates to online sales platform 302 that the purchasable is to be posted on other online marketplaces, i.e. ebay®, should the purchasable not be sold on online sales platform 302 in a timely manner. For example, at the same time as offer emails are sent to the third group, online sales platform 302 logs into seller 308a's ebay® account and automatically posts an ad for motorcycle 318. Alternatively, data 314 and 316 indicates that providing a time limited offer to the third group would increase the probability of selling motorcycle 318 more quickly. A limited time offer is made to the third group. Upon expiry of the offer to the third group online sales platform 302 logs into seller 308a's ebay® account and automatically posts an ad for motorcycle 318.

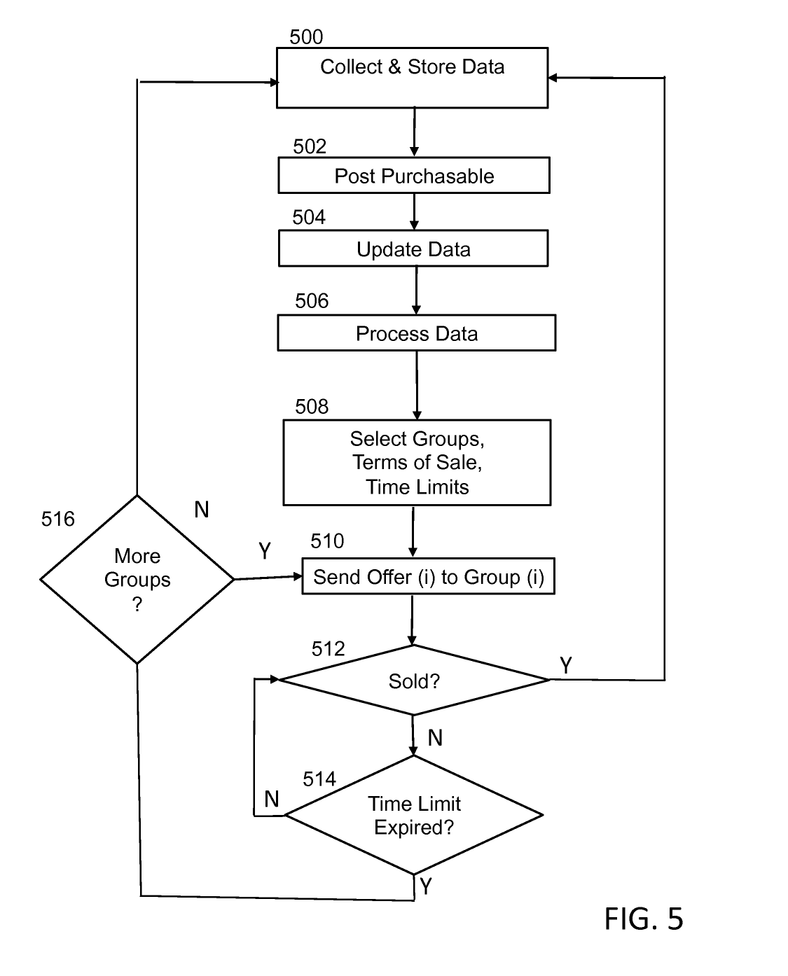

Shown in FIG. 4 is a simplified flow diagram of a process for selling a purchasable on an online sales platform according to an embodiment of the invention. At 400, historical data indicative of past buyer behavior, purchasable descriptions, terms of sale, and seller information is collected and stored. A seller posts an ad for a purchasable on the online sales platform at 402. The historical data is updated to include new data indicative of the newly posted purchasable description, terms of sale, seller goals and seller information at 404. The updated data is processed at 406 to determine a combination of a first group of buyers and a first sales offer to provide thereto at 408. The first sales offer includes the terms of sale and the time limit the first offer is valid. This combination of offering the first sales offer to the first group maximizes the probability of achieving the short term and long term business goals indicated by the seller in comparison to other combinations of buyers and offers. At 410, the first sales offer is electronically provided to members of the first group. At 412, the status of the sale is checked—if the purchasable has been sold to a member of the first group, the selling process repeats at step 400 wherein the historical data is updated with new data indicative of buyer behavior. However, if the purchasable has not been sold, at 414, the expiration of the first offer time limit is checked. If the offer time limit is not expired, the process returns to 412 wherein the status of the sale is checked. Otherwise, if the first offer time limit has expired, at 416, it is evaluated whether the combinations of groups and offers has been exhausted. If not, the process returns to 406 wherein the historical data is processed to determine a combination of a second group of buyers and a second sales offer to provide thereto. The second sales offer includes other terms of sale and another time limit within which the second offer is valid. This combination of providing the second sales offer to the second group of buyers is the second most likely combination to achieve the short term and long term business goals indicated by the seller in comparison to other combinations of buyers and offers. If the combinations of groups and offers are exhausted, the selling process returns to 400 wherein the historical data is updated with new data indicative of the details of buyer behavior—wherein the purchasable is other than sold.

Shown in FIG. 5 is a simplified flow diagram of a process for selling a purchasable on an online sales platform according to an embodiment of the invention. At 500, historical data indicative of past buyer behavior, purchasable descriptions, terms of sale, and seller information is collected and stored. A seller posts an ad for a purchasable on the online sales platform at 502. The historical data is updated to include new data indicative of the newly posted purchasable description, terms of sale, seller goals and seller information at 504. The updated data is processed at 506 to determine combinations of the groups of buyers and sales offers to provide to each group at 508. The sales offers includes the terms of sale for each group and the time limit the sales offers are valid. The combinations of offering the sales offers and groups maximizes the probability of achieving the short term and long term business goals indicated by the seller in comparison to other combinations of buyers and offers. At 510, the first sales offer is electronically provided to members of the first group. At 512, the status of the sale is checked—if the purchasable has been sold to a member of the first group, the selling process repeats at step 500 wherein the historical data is updated with new data indicative of buyer behavior. However, if the purchasable has not been sold, at 514, the expiration of the first offer time limit is checked. If the offer time limit is not expired, the process returns to 512 wherein the status of the sale is checked. Otherwise, if the first offer time limit has expired, at 516, it is evaluated whether the combinations of groups and offers has been exhausted. If not, the process returns to 510 wherein the second sales offer is provided to the second group. This combination of providing the second sales offer to the second group of buyers is the second most likely combination to achieve the short term and long term business goals indicated by the seller in comparison to other combinations of buyers and offers. If the combinations of groups and offers are exhausted, the selling process returns to 500 wherein the historical data is updated with new data indicative of the details of buyer behavior—wherein the purchasable is other than sold. Other processes can be envisioned to select combinations of the groups of buyers and sales offers to provide to each group to maximize the probability of achieving the short term and long term business goals indicated by the seller.

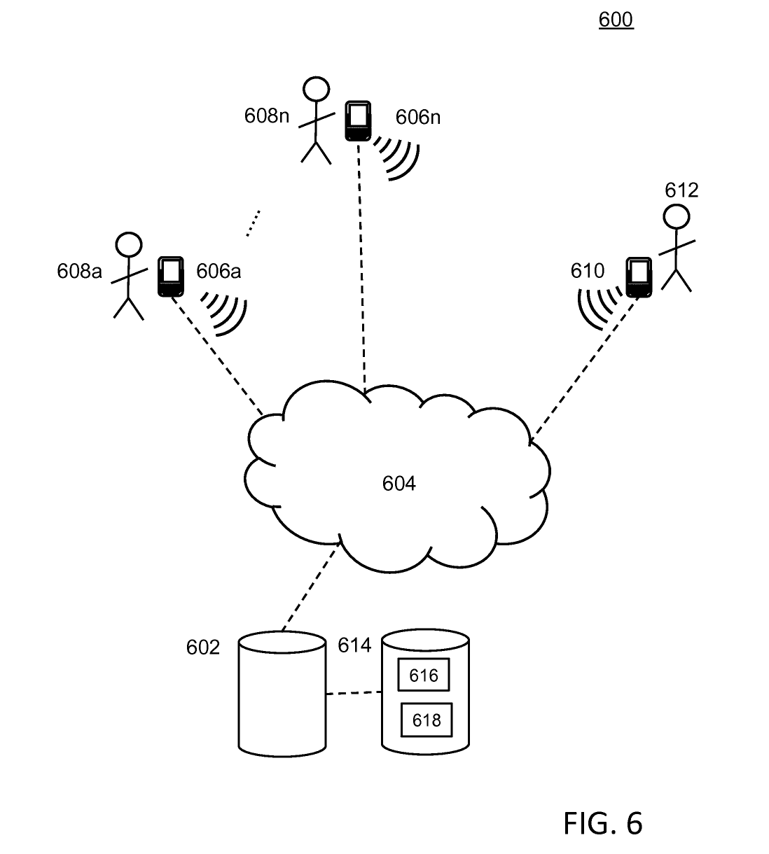

Shown in FIG. 6 is a simplified block diagram of a system according to an embodiment of the invention. System 600 comprises an online sales platform 602 in the form of a server, coupled to a network 604, for example, the Internet, and communication devices 606a-606n and 610, also coupled to network 604. Alternatively, the online platform 602 is in the form of a distributed network. Specific and non-limiting examples of communication devices 606a-606n and 610 include computers, smartphones and tablets. Online sales platform 602 provides an electronic service for the online sale and purchase of purchasables to users—sellers and buyers. In this example, seller 612 and buyers 608a-608n use their associated communication devices, 610 and 606a-606n respectively, to receive messages from, and to access, online service platform 602 via network 604. In use, both sellers and buyers register with online sales platform 602 by providing contact information thereto. A specific and non-limiting example of contact information is an email address. At the time of registration, users are associated with a secret password for user verification purposes when logging into the online sales platform 602. Alternatively, security processes using other security information are implemented for user verification during login. User contact and associated security information are stored in a data store. In this example, user information is stored in the same server as online sales platform 602. Optionally, the user is associated with a username for use during user verification at login, the username is also stored in a data store and associated with the user contact and associated security information.

Seller 612 information is provided on the post and is available to buyers. Specific and non-limiting examples include seller name, address, contact information, and buyer feedback. Alternatively, a seller restricts the seller information that is provided to buyers.

For each of the buyers 608a-608n, shopping behaviors are tracked by online sales platform 604, and data 616 indicative thereof is stored in a data store, for example, in server 614 in communication with online sales platform 602. Data 616 also comprises data associated with purchasables bought by a buyer, for example, data extracted from the online description of a purchasable, seller goals, seller information, and terms of sale under which the purchasable was bought. Data 616 is processed to interpret buyers 608a-608n shopping behaviors in a meaningful way. Such as identifying patterns in buyer shopping behavior, identifying a plurality of associated shopping behaviors and to anticipate future shopping behavior. Optionally, data 616 also comprises data indicative of personal information provided by the buyer to the online sales platform 602. Specific and non-limiting examples include occupation, location, age and gender. Profile data of online shoppers collected by a third party vendor is associated with buyers 608a-608n. For example, personal information provided by a buyer indicates that he is a 20 year old male student working in the retail industry. Profile data for online shoppers of similar demographics indicates that these shoppers have a high tendency to purchase used electrical and entertainment items such as video games, smartphones, laptops and TVs. The associated data provides additional buyer behavior information for use in interpreting buyers shopping behaviors in a meaningful way. Furthermore, profile data is associated with identified shopping behaviors of a buyer. For example, an identified shopping behavior of a buyer is their preference for Art Deco jewelry. Profile data for online shoppers with similar tastes also have a high tendency to purchase Art Nouveau jewelry. Alternatively, profile data of buyers is collected via data mining of data. A specific and non-limiting example includes data mining by the online sales platform of data available via the Internet. Optionally, data collected via data mining is processed to form profile data of buyers.

For a given purchasable, data 616 is processed to identify a hierarchy of groups of buyers from buyers 608a-608n wherein each identified group receives a limited time sales offer unique to that group. The limited time sales offers are provided sequentially to each group according to the position of the group's hierarchical rank. Optionally, a plurality of groups occupy the same rank in the hierarchy of groups. Furthermore, the offers are non-contemporaneous, in other words, the windows of time each sales offer provided to a group is valid do not overlap. Alternatively, limited time sales offers are contemporaneous. Data 616 is processed to select the members of each group and a sequence of offers to be provided to the groups that would maximize the probability of achieving the short term and/or long term business goals indicated by a seller. Methods used to process data 616 are influenced by the seller's goals. A specific and non-limiting example includes a first mathematical/statistical model is applied to data 616 when the seller has a short term goal of selling a purchasable as quickly as possible. However, a second other mathematical/statistical model is applied to data 616 when the seller has a long term goal of building a customer base in a specific geographical region. Finally, data 618 resulting from the processing of data 616 is stored in a data store, for example, in server 614. For each new purchasable posted for sale and subsequently sold on the online sales platform 602, data 616 is automatically updated and processed resulting in new data 618. Changes in buyer behavior and seller goals are automatically reflected in updated data 616 and 618.

In this embodiment, seller 612 provides long term business goal data to online sales platform 602. For example, seller 612 indicates to online sales platform 602 that an increase of sales by 20% each year for the next 5 years is his long term business goal. As such, the identification of the hierarchy of groups of buyers from buyers 608a-608n and each limited time sales offer provided to each group is influenced by the long term business goal indicated by seller 612. For example, for a plurality of purchasables posted by seller 612 on online platform 602, the hierarchy of groups and associated offers are selected to foster long term trusting relationships with buyers. A specific and non-limiting example includes providing repeat customers the first sales offer for any purchasables posted by seller 612. Optionally, the terms of sale of the first sales offer are also customized to foster long term trusting relationships with buyers. For example, only repeat customers are offered a discount from the market rate of a purchasable. Although the sale of an individual purchasable may not result in the highest profit possible, this strategy results in steady business growth and increase of profits over the 5 year period.

Alternatively, the seller indicates a long term business goal of growing the customer base within a specific geographic region. Alternatively, the long term business goal is not profit based, for example, the seller indicates a long term business goal of selling purchasables to non-profit organizations, the under-privileged, environmentally conscious customers, etc. Alternatively, the seller indicates another long term business goal. Alternatively, the seller indicates a plurality of long term goals. Optionally, the seller indicates the relative importance of each of the plurality of long term goals. Alternatively, the seller indicates a short term goal of the individual sale. For example, to sell a purchasable as quickly as possible. Alternatively, the seller indicates a plurality of short term goals. Optionally, the seller indicates the relative importance of each of the plurality of short term goals. Many other short term and long term business goals can be envisioned.

In the embodiments described above, sellers have the option to provide custom data associated with the sale of purchasables that influences the selection of the groups of buyers and each group's rank within the hierarchy. Optionally, the seller provides custom data associating buyers of the online sales platform with limitations/exceptions. For example, an importer sells and ships exotic dairy foods to European delis in the U.S., for example, unpasteurized goat cheese. Dairy sales are regulated by each state wherein some states do not allow unpasteurized dairy products to be sold to the public. The seller provides custom data indicating that unpasteurized products are not to be offered to buyers located in certain states. The seller posts unpasteurized goat cheese on to an online sales platform. Any buyers located in states that prohibit the sale of unpasteurized cheese are not selected for any buyer groups and thus are not provided an offer of sale for the unpasteurized goat cheese.

Furthermore, the seller has the option to provide custom data associated with individual buyers, enabling the seller to directly influence a buyer's experience with the seller and the seller's products. For example, a seller indicates that a particular buyer is to always be included in the first group of buyers to receive the first sales offer. Another example includes a preferred buyer is to be offered a warranty for each purchasable posted by the seller. Optionally, the online sales platform seeks buyer specific information on the Internet collecting custom data. For example, the online sales platform performs an automatic credit check for buyers. Buyers that have bad credit are not selected for any buyer groups and thus is not provided an offer of sale for a purchasable.

Optionally, the online sales platform filters the custom data provided by the seller. For example, a seller indicates to the online sales platform that a first buyer is to be selected for the first group and thus provided the first sales offer of a purchasable. The seller has approved a charge account for the first buyer and an invoice is sent monthly for any purchasables bought by the first buyer that month. However, buyer data comprises account balance data for buyers with charge accounts. The first buyer did not pay last month's invoice and is in arrears. Although the seller indicated the first buyer was to be included in the first group, the online sales platform excludes the first buyer from the any group of buyers and the first buyer is not provided a sales offer for the purchasable. If the seller does not provide custom data, then the online sales platform uses default data.

Optionally, the custom data influences the sales offers provided to each group of buyers. Specific and non-limiting examples of custom data include terms of sale, refund policy, time limit of sales offers, preferred buyers, groups of preferred buyers and rank within the hierarchy, geographic location of buyers, description data of purchasable provided to each group, type of auction, type of auction offered to each group, etc

According to another embodiment of the invention, a buyer influences the offers of sale provided by the online sales platform to the buyer. A specific and non-limiting example includes a buyer is unsatisfied with the quality of past purchasables he bought from a seller. The buyer indicates to the online platform that he does not want to receive future offers of sale from that seller even if the buyer is selected for a buyer group for the seller's purchasable. Another specific and non-limiting example includes, chocolatiers frequently sell excess chocolate by the pound post holidays, i.e. Christmas, Easter, etc. A buyer will only purchase one pound of chocolate after every holiday. The buyer indicates to the online sales platform that if he is provided an offer of sale by one chocolatier after a recent holiday, and he makes a purchase, that he does not want to receive any other offers from any other chocolatiers. Alternatively, a buyer can prioritize offers of sale from sellers according to the buyer's preference. For example, a used car dealer purchases used cars from various wholesalers, usually on a daily basis. The dealer checks his email for offers of sale every evening. If his preferred wholesaler posts used cars for sale on a given day he does not want to be provided with offers of sale from any other wholesaler that day. If his preferred wholesaler does not post any used cars for sale on a given day, he would like to receive offers of sale from his wholesaler of second choice.

The embodiments presented are exemplary only and persons skilled in the art would appreciate that variations to the embodiments described above may be made without departing from the scope of the invention.

What is claimed is:

1. A method comprising:
providing an indication that a purchasable is for sale by a seller to an online sales platform connected to a communication network;
coupling a plurality of communication devices to the communication network for communication to the online sales platform;
providing buyer data for a plurality of buyers, the buyer data indicative of online shopping behavior of each buyer of the plurality of buyers, wherein each buyer of the plurality of buyers is associated with a communication device of the plurality of communication devices;
selecting a first group and a second group of buyers from the plurality of buyers in dependence on the buyer data, the first group of buyers comprising at least a first buyer, the second group comprising at least a second buyer, the first buyer other than the second buyer;
providing a first offer of sale of the purchasable to each buyer of the first group of buyers and other than providing the first offer of sale of the purchasable to other than each buyer of the first group of buyers, wherein the first offer of sale is accessible to each of the buyers of the first group of buyers via one of the associated plurality of communication devices; and
when a request to purchase the purchasable is other than received from one of the buyers of the first group via one of the plurality of associated communication devices, automatically providing a second offer of sale of the purchasable to each buyer of the second group, wherein the second offer of sale is accessible to each of the buyers of the second group of buyers via one of the associated plurality of communication devices.

2. The method according to claim 1 wherein selecting is automatically performed by the online sales platform.

3. The method according to claim 2 wherein selecting the first group of buyers and selecting the second group of buyers is in dependence on data provided by the seller.

4. The method according to claim 3 wherein the data provided by the seller is indicative of the seller's preference to select at least the first buyer from the plurality of buyers to be selected in the first group.

5. The method according to claim 4 wherein selecting the first group of buyers and selecting the second group of buyers comprises automatically other than selecting a second buyer from the plurality of buyers by the online sales platform wherein the data provided by the seller is indicative of the seller's preference to select the second buyer from the plurality of buyers to be in the first group.

6. The method according to claim 2 comprising automatically determining first terms of the first offer of sale and second terms of the second offer of sale by the online sales platform the first the terms other than the second terms.

7. The method according to claim 6 wherein the first offer of sale and the second offer of sale is dependent upon data provided by the seller.

8. The method according to claim 6 wherein the data provided by the seller is description data of the purchasable.

9. The method according to claim 8 wherein the description data comprises first description data and second description data and wherein selecting the first group of buyers is dependent upon the first description data and selecting the second group of buyers is dependent upon the second description data.

10. The method according to claim 2 wherein buyer data comprises personal data provided by each buyer of the plurality of buyers.

11. The method according to claim 2 comprising associating profile data of online shoppers provided by a 3^{rd} party with at least a buyer from the plurality of buyers and updating the buyer data to include the associated profile data.

12. The method according to claim 3 wherein the data provided by the seller comprises goal data.

13. The method according to claim 7 wherein the data provided by the seller is buyer data.

14. The method according to claim 7 wherein the data provided by the seller is description data of the purchasable.

15. The method according to claim 7 wherein the data provided by the seller is goal data.

16. The method according to claim 1 comprising automatically updating buyer data with new data by the online sales platform, the new data indicative of a buyer's most recent purchase of a last purchasable.

17. The method according to claim 2 wherein providing the first offer of sale comprises electronically transmitting an indication of the first offer of sale to the communication device of each buyer in the first group and wherein providing the second offer of sale comprises an indication of the second offer of sale to the communication device of each buyer of the second group.

18. The method according to claim 17 wherein the first offer of sale expires at time t1 and the second offer of sale expires at time t2, t1 other than t2.

19. The method according to claim 17 wherein the second offer of sale is provided to each member of the second group automatically by the sales platform upon expiration of the first offer of sale.

20. The method according to claim 2 wherein terms of the first offer of sale is other than terms of the second offer of sale.

21. The method according to claim 2 wherein if a request to purchase the purchasable is other than received from one of the plurality of communication devices associated with one of the buyers of the first group the purchasable is posted for sale by the online sales platform on a 3^{rd} party sales platform.

22. The method according to claim 2 wherein selecting the first group of buyers and the second group of buyers comprises processing the buyer data to provide probability data indicative of the future shopping behavior of each of the buyers in the plurality of buyers.

23. The method according to claim 22 wherein processing the buyer data comprises applying a mathematical/statistical model to the buyer data.

24. The method according to claim 23 comprising processing the data provided by the seller wherein processing comprises applying a mathematical/statistical model to the data provided by the seller.

25. The method according to claim 2 wherein the communication network is a mobile network.

26. The method according to claim 1 comprising collecting buyer data by data mining data relating to buyers and their buying activity.

27. The method according to claim 2 comprising collecting buyer data by data mining data relating to buyers and their buying activity.

28. A method comprising:
providing an indication that a purchasable is for sale by a seller to an online sales platform connected to a communication network;
coupling a plurality of communication devices to the communication network for communication to the online sales platform,
each buyer of the plurality of buyers is associated with a communication device of the plurality of communication devices;
providing buyer data for each buyer of the plurality of buyers, the buyer data indicative of online shopping behavior of each buyer of the plurality of buyers;
selecting a first group and a second group of buyers from the plurality of buyers in dependence on the buyer data and data provided by the seller, the first group of buyers comprising at least a first buyer, the second group comprising at least a second buyer, the first buyer other than the second buyer, wherein the data provided by the seller is indicative of the seller's preference to select at least the first buyer from the plurality of buyers to be selected in the first group;
automatically determining a first offer of sale and a second offer of sale by the online sales platform wherein the first offer of sale and the second offer of sale are dependent on the data provided by the seller, the first offer of sale expiring at a time t1 and the second offer of sale expiring at a time t2, t1 other than t2;
providing the first offer of sale of the purchasable to each buyer of the first group of buyers and other than providing the first offer of sale of the purchasable to other than each buyer of the first group of buyers, wherein the first offer of sale is accessible to each of the buyers of the first group of buyers via one of the associated plurality of communication devices; and
when a request to purchase the purchasable is other than received from one of the buyers of the first group via one of the plurality of associated communication devices and the first offer of sale is expired, automatically providing the second offer of sale of the purchasable to each buyer of the second group, wherein the second offer of sale is accessible to each of the buyers of the second group of buyers via one of the associated plurality of communication devices.

29. A system comprising:
a communication network;
a plurality of communication devices coupled to the communication network, each of the plurality of communication devices associated with each buyer of a plurality of buyers; and
an online server coupled to the communication network for communicating with the plurality of communication devices comprising:
a memory store for storing buyer data indicative of online shopping behavior of each buyer of the plurality of buyers; and
a processor for processing the buyer data for automatically selecting a first group and second group of buyers from the plurality of buyers in dependence on the buyer data and for providing a first offer of sale to each communication device associated with each buyer of the first group of buyers via the communication network and other than providing the first offer of sale of the purchasable to each communication device associated with other than each buyer of the first group of buyers and when a request to purchase the purchasable is other than received from each communication device associated with each buyer of the first group of buyers and the first offer of sale is expired, automatically providing a second offer of sale of the purchasable to each communication device associated with each buyer of the of the second group of buyers.
